(19) United States
(12) Patent Application Publication
(10) Pub. No.: US 2024/0281432 A1
(43) Pub. Date: Aug. 22, 2024

(54) DYNAMIC BATCHING OF GLOBAL LOCKS IN A DATA SHARING SYSTEM

(71) Applicant: MICROSOFT TECHNOLOGY LICENSING, LLC, Redmond, WA (US)

(72) Inventors: Philip Alan BERNSTEIN, Bellevue, WA (US); Spyridon BLANAS, Columbus, OH (US); Mohamed Amine MHEDHBI, Waterloo (CA)

(21) Appl. No.: 18/325,981

(22) Filed: May 30, 2023

Related U.S. Application Data
(60) Provisional application No. 63/447,601, filed on Feb. 22, 2023.

(51) Int. Cl. G06F 16/23

(52) U.S. Cl. CPC G06F 16/2386; G06F 16/2343

(57) ABSTRACT

Methods and apparatuses for improving the performance and energy efficiency of a database system are described. A database system may dynamically adjust transaction batch sizes on a per node basis. In some cases, the database system may detect that a “hot lock” condition exists for a particular page or that a node-lock has ping-ponged between two database nodes at least a threshold number of times within a threshold period of time, and in response, may adjust (e.g., temporarily increase) the batch size or the number of transactions performed by a node before releasing the node-lock.

### CLAIM OF PRIORITY

This application claims the benefit of and priority to U.S. Provisional Application No. 63/447,601, filed Feb. 22, 2023, which is herein incorporated by reference in its entirety.

### BACKGROUND

A database management system (DBMS) may refer to software that interacts with applications and databases to capture and analyze data. One type of DBMS is a relational database management system (RDBMS) that may utilize a query language, such as Structured Query Language (SQL), to query, update, and retrieve data stored within a database. A database server may comprise a server that executes a DBMS and provides database services using the DBMS. To improve database system performance, a buffer pool (or buffer cache) may be utilized. A buffer cache may comprise a portion of memory into which database pages are temporarily stored or cached. The size of a database page (or page) is typically between 512 B and 64 KB of data.

### BRIEF SUMMARY

Systems and methods for improving the performance and energy efficiency of a database system are provided. The database system may dynamically adjust transaction batch sizes for database nodes within the database system. In some cases, the database system may detect that a “hot lock” condition exists for a particular page or that a node-lock has ping-ponged between two database nodes at least a threshold number of times within a threshold period of time (e.g., an exclusive node-lock has been set and released by two different nodes within the past 30 milliseconds). Upon detection of the “hot lock” condition, a node within the database system may adjust (e.g., increase or decrease) the batch size or the number of transactions performed by the node before releasing a node-lock. In one example, the node may increment the number of transactions performed by the node before releasing the node-lock up to a maximum number of transactions (e.g., up to 20 transactions). The batch size for a node may refer to the number of transactions that the node may execute before releasing a node-lock or the maximum number of transactions during which the node may hold a node-lock.

In some embodiments, a database node may set or adjust the number of transactions per node-lock for a particular page based on an average message delay for setting and releasing node-locks, a network bandwidth for a network over which database messages are transmitted, and/or the number of times that a node-lock has ping-ponged between two nodes within a past threshold period of time (e.g., within the past five seconds).

According to some embodiments, the technical benefits of the systems and methods disclosed herein include reduced energy consumption and cost of computing resources, reduced database downtime, and improved database system performance. Other technical benefits can also be realized through implementations of the disclosed technologies.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1A depicts one embodiment of database nodes passing messages to set and release a node-lock for a page.

FIG. 1B depicts one embodiment of a networked computing environment in which the disclosed technology may be practiced.

FIG. 1C depicts one embodiment of a database system.

FIG. 2 depicts one embodiment of various components of a database system.

FIG. 3A depicts one embodiment of transactions being performed by two database nodes.

FIG. 3B depicts one embodiment of transactions being performed by the two database nodes depicted in FIG. 1C.

FIG. 3C depicts one embodiment of transactions being performed by the two database nodes depicted in FIG. 1C.

FIG. 3D depicts another embodiment of transactions being performed by the two database nodes depicted in FIG. 1C.

FIG. 3E depicts an alternative embodiment of transactions being performed by the two database nodes depicted in FIG. 1C.

FIGS. 4A-4B depict a flowchart describing one embodiment of a process for dynamically adjusting batch size while executing database transactions.

FIG. 5 depicts a flowchart describing an embodiment of a process for dynamically adjusting batch execution time while executing database transactions.

### DETAILED DESCRIPTION

The technologies described herein utilize dynamic batching of transactions to improve the performance and energy efficiency of a data sharing database system that uses a global lock manager to arbitrate access to shared data to ensure cache coherence. The data sharing database system may include two or more database system instances (or nodes) that read and write the same shared copy of a database. In a data sharing database system, when a transaction accesses a database record, a DBMS node fetches into its buffer cache a page that contains the database record. If two transactions T1 and T2 executing concurrently in two different DBMS instances attempt to update the same database record, then a data error may occur. For example, since neither transaction reads the other transaction's output, transaction T2 may overwrite an update that was made to a page by the other transaction T1.

To prevent this erroneous outcome, the data sharing database system must ensure that at any given time, only one DBMS node has the ability to update each page. One way to achieve this is by using a global lock manager (GLM). In this case, before reading or writing a page, a DBMS node may set a “share” or “exclusive” node-lock (or lock) on the page at the GLM. A share node-lock (or S-node-lock) may ensure that no other DBMS node has an exclusive lock on the page. An exclusive node-lock (or X-node-lock) may ensure that no other DBMS node has an S-node-lock or X-node-lock on the page.

If two transactions T1 and T2 execute concurrently in two different DBMS nodes N1 and N2, respectively, and attempt to update the same page P, then they will fight over the X-node-lock on page P. For example, suppose node N1 obtains the X-node-lock on page P first. Then N2's request to lock page P will be queued by the GLM until N1 releases its lock. The GLM will notify N1 that N2 is waiting for the lock. As soon as N1 finishes executing a number of transactions and/or updates a number of database records, then N1 may release its node-lock on page P which allows N2 to obtain the node-lock and perform updates to page P. Also, N1 may send the updated copy (or most recent copy) of page P to N2. Now suppose that page P has a “hot lock” condition, meaning that transactions from two or more different DBMS nodes that update page P are being executed at a high rate. In this situation, as soon as node N2 obtains the lock on page P, N1 may start running a transaction that needs to update page P and will be blocked waiting for the X-node-lock on page P at the GLM, which notifies N2 that N1 is waiting for the lock. The transaction throughput in this situation may depend on how fast the X-node-lock can ping-pong back and forth between nodes N1 and N2.

A technical issue with using a GLM is that the GLM may only be co-located with one node. This means that other nodes must transmit messages to the GLM in order to set and release node-locks. The network delay of those messages limits the rate at which a node can set and release the lock, and therefore limits transaction throughput. In some cases, since a message delay can be more than ten times the execution time of a transaction, this throughput limitation can be significant.

In some embodiments, a data sharing database system may detect that a “hot lock” condition exists for a particular page or that a node-lock has ping-ponged (or been exchanged) between two DBMS nodes at least a threshold number of times within a threshold period of time (e.g., an X-node-lock has been set and released for two different nodes three times within the past 30 milliseconds). Upon detection of a “hot lock” condition or a node-lock contention condition (e.g., when two or more database servers are concurrently requesting node-locks in order to perform updates on the same page), a node within the data sharing database system may adjust (e.g., increase or decrease) the batch size or the number of transactions performed by a node before releasing a node-lock. In one example, a node may increment the number of transactions performed by the node before releasing the node-lock up to a maximum number of transactions (e.g., up to a maximum of 20 transactions). The batch size for a node may refer to the number of transactions that the node may execute before releasing a node-lock. The batch size may be adjusted on a per node basis. A technical benefit of adjusting the batch size in response to detection of a “hot lock” condition or a node-lock contention condition is that the time wasted due to message delays for setting and releasing node-locks may be reduced, thereby improving the performance of the data sharing database system.

Increasing the number of transactions performed by a node before the node allows a node-lock to be released may enable an increased number of transactions to execute each time the data sharing database system incurs a message delay when accessing the GLM. For example, consider the case where N1 owns the node-lock on page P and the GLM tells N1 that N2 is waiting for the lock. If N1 has another local transaction T3 that is waiting for the lock, then it doesn't release its lock on page P immediately. Instead, it executes the local transaction T3 before releasing the lock. Node N1 may also increase its batch size (e.g., from one transaction to two transactions), which means that in the future, N1 will execute a greater number of transactions each time it obtains the page P lock. Therefore, in some cases, the longer the data sharing database system experiences contention on an X-node-lock for a page P, the larger the batch sizes will grow for nodes within the data sharing database system that are updating page P, thereby amortizing the cost of obtaining node-locks via message passing over a network. The batch sizes may be allowed to grow until they reach a maximum batch size, as the maximum batch size corresponds with the maximum amount of time that other nodes may be stalled and prevented from obtaining a high-contention lock.

In some embodiments, a node may set or adjust the number of transactions per node-lock for a particular page based on an average message delay for setting and releasing node-locks, a network bandwidth for a network over which database messages are transmitted, and/or the number of times that a node-lock has ping-ponged between two nodes within a past threshold period of time (e.g., within the past five seconds).

In some embodiments, if a node detects that it has transactions to be executed that are waiting for a node-lock when it completes its batch, then the node may increase its batch size (e.g., increase the batch size by two). Conversely, if the node detects that it has no transactions to be executed and that it is holding a node-lock, then the node may release the node-lock prematurely and decrease its batch size (e.g., reduce the batch size by one). The batch size may be dynamically adjusted on a per node basis. If a node detects that contention for the node-lock has increased, then the batch size may be increased; however, if the node detects that contention for the node-lock has decreased, then the batch size may be decreased.

In some cases, to avoid the rapid oscillation of the batch size, the database system may introduce hysteresis. For example, instead of immediately decreasing the batch size when a node doesn't have enough transactions to fill the batch, the node could wait for a few rounds, to make sure the workload has indeed become lighter.

In some cases, instead of adjusting the batch size or controlling the number of transactions per batch, the data sharing database system may control the execution time of page accesses per batch. This may be technically beneficial if there is high variance in the amount of time that a transaction performs operations on a page.

In some embodiments, a database lock may be configured or implemented as an exclusive lock (or write lock) or a shared lock (or read lock). A read lock may allow a page to be read concurrently by multiple database instances, as long as no database instance has a write lock on the page. Ordinarily, a read lock associated with transactions that require a serializable isolation level will be granted for the page only if there is no write lock for the page. In one example, suppose node N1 has a write lock on page P and node N2 requests a read lock because node N2 is running a transaction that wants to read but not write page P. If node N2's transaction is required to be serializable, then it needs to read the value of page P written by the last transaction at node N1 that updated page P. Therefore, before granting node N2's request, node N1 must release its write lock on page P. Then a copy of the updated page P may be transmitted to node N2 along with an acknowledgement that node N2 has obtained a read lock for page P. However, if node N2's transaction executes at a weaker isolation level (e.g., a read committed isolation level), then node N2 could use a prior value of page P. In this case, node N2 may be granted a read lock on page P even though node N1 has a write lock on page P. The determination of whether to transfer an updated copy of page P from node N1 that has a write lock for page P to node N2 that has requested a read lock for page P may depend on an isolation level for one or more transactions to be executed by node N2. For example, if one or more of the transactions to be executed by node N2 requires a serializable isolation level, then node N1 may transfer the most up-to-date version of page P and an acknowledgement that node N2 has obtained a read lock for page P.

In some cases, concurrency issues may occur in a database system if transactions running concurrently modify and access the same data within the database system. Transaction isolation may prevent concurrency issues by ensuring that read and write operations are serializable. An isolation level (or database isolation level) may refer to a degree to which a transaction must be isolated from data modifications made by other transactions within the database system. A range of isolation levels may be determined ranging from a lowest isolation level (or the weakest isolation level) to a highest isolation level (or strongest isolation level). The lowest isolation level may correspond with a read uncommitted isolation level in which transactions are not isolated from each other during execution. In this case, a transaction may read data even if changes have not yet been committed by another transaction, thereby potentially resulting in a dirty read. A higher isolation level may correspond with a read committed isolation level in which any data read is committed at the moment it is read. In this case, only committed data may be read from the database system. The highest isolation level may correspond with a serializable isolation level in which transactions executed concurrently appear to be serially executing or are executed sequentially to ensure that no dirty reads occur. In general, the higher the isolation level of the transaction, the greater the protection against concurrency issues, but at the cost of decreased performance.

In some cases, row-level write locks or exclusive node-locks may be used to lock data in a transaction so that other transactions have to wait for the lock to release before they can change data within the same row in a database. In some cases, page-level write locks or exclusive node-locks may be used to lock data in a transaction so that other transactions have to wait for the lock to release before they can change data within the same page. As an example, the page size may comprise 512 B of data, 4 KB of data, or 64 KB of data.

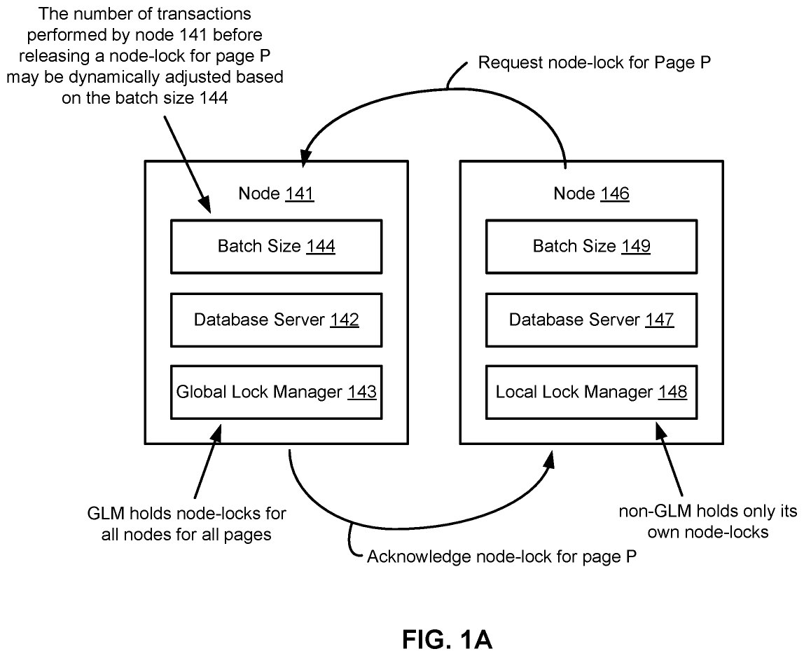

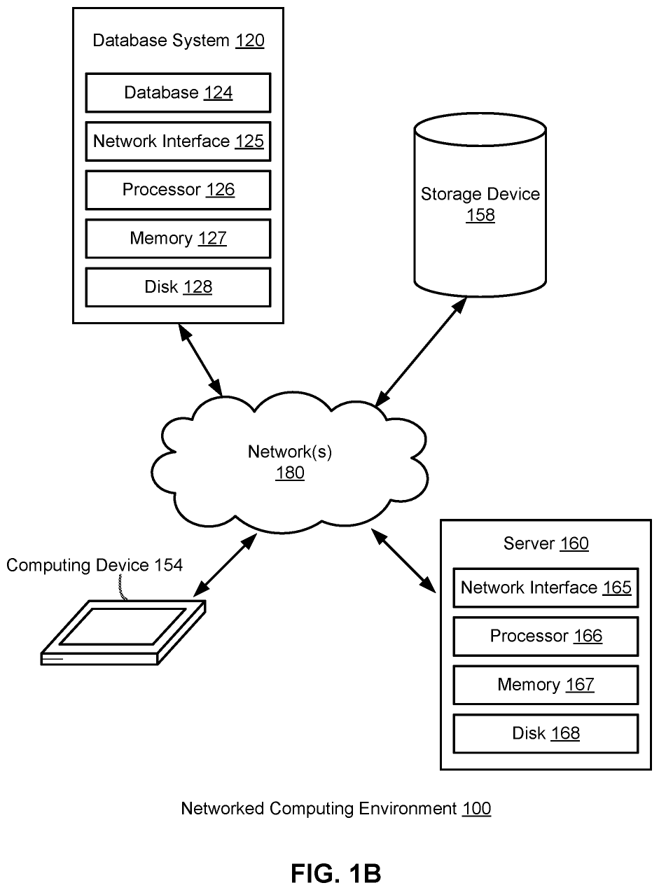

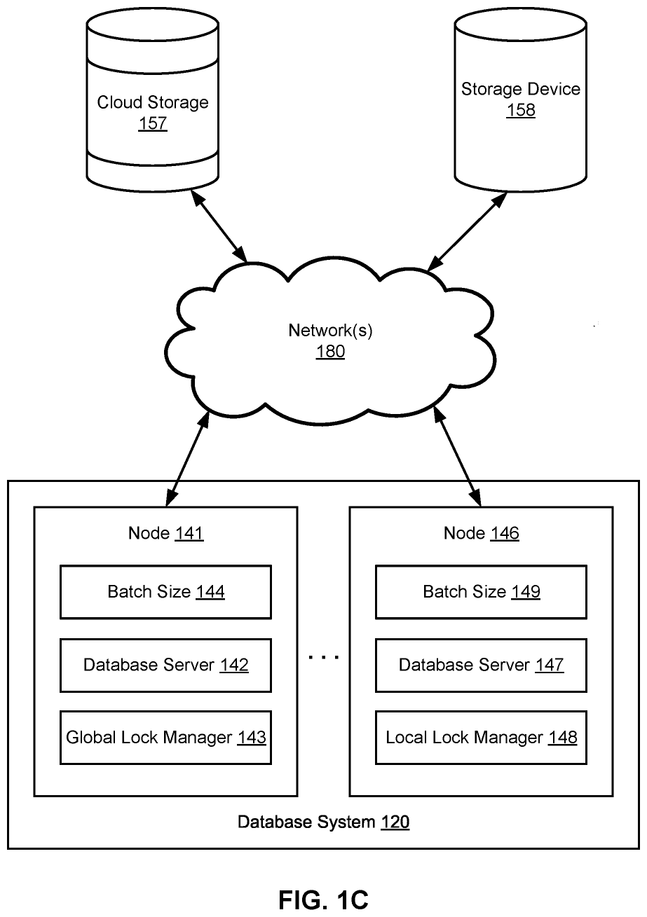

FIG. 1A depicts one embodiment of two database nodes passing messages to set and release a node-lock for a page P. The GLM 143 may manage and store node-locks for all nodes, including nodes 141 and 146, for all pages. The local lock manager 148 may only locally store node-locks for the node 146. The node 146 may request a node-lock for page P from the GLM 143 by transmitting a request, such as GetNodeLock(Page P), to the GLM 143 running on node 141. In response, the GLM 143 may transmit an acknowledgement that node 146 has acquired the node-lock for page P after the node-lock for page P has been released by node 141. The GLM 143 may ensure that only one node within a database system may have a node-lock for page P at a time.

A distributed database system may include a plurality of nodes including node 141 and node 146. Node 141 includes a database server 142, global lock manager 143, and batch size 144. The batch size 144 may be stored in a volatile or non-volatile memory. The batch size 144 may be dynamically adjusted over time to adjust the number of transactions performed by the node 141 before releasing a node-lock for page P. Node 146 includes a database server 147, local lock manager 148, and batch size 149. The batch size 149 may be stored in a volatile or non-volatile memory. The batch size 149 may be dynamically adjusted over time to adjust the number of transactions performed by the node 146 before releasing a node-lock for page P. The database server 142 and database server 147 may comprise database instances. The local lock manager 148 may correspond with a non-GLM lock manager. The GLM 143 may comprise the global lock manager for the distributed database system.

FIG. 1B depicts one embodiment of a networked computing environment 100 in which the disclosed technology may be practiced. The networked computing environment 100 includes a database system 120, storage device 158, server 160, and a computing device 154 in communication with each other via one or more networks 180. The networked computing environment 100 may include various computing and storage devices interconnected through one or more networks 180. The networked computing environment 100 may correspond with or provide access to a cloud computing environment providing Software-as-a-Service (SaaS) or Infrastructure-as-a-Service (IaaS) services. The one or more networks 180 may allow computing devices and/or storage devices to connect to and communicate with other computing devices and/or other storage devices. In some cases, the networked computing environment 100 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 180 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 100 may comprise real hardware computing devices or virtual computing devices, such as one or more virtual machines. The storage devices within the networked computing environment 100 may comprise real hardware storage devices or virtual storage devices, such as one or more virtual disks. The read hardware storage devices may include non-volatile and volatile storage devices.

The database system 120 may comprise a data sharing database system that includes a set of database instances (or nodes) that may each access a shared storage layer or a shared storage device. In some cases, the database system 120 may utilize dynamic batching of transactions to improve the performance and energy efficiency of the database system 120. As depicted in FIG. 1B, the database system 120 includes a database 124, network interface 125, processor 126, memory 127, and disk 128 all in communication with each other. The database 124, network interface 125, processor 126, memory 127, and disk 128 may comprise real components or virtualized components. In one example, the database 124, network interface 125, processor 126, memory 127, and disk 128 may be provided by a virtualized infrastructure or a cloud-based infrastructure. Network interface 125 allows the database system 120 to connect to one or more networks 180. Network interface 125 may include a wireless network interface and/or a wired network interface. Processor 126 allows the database system 120 to execute computer readable instructions stored in memory 127 in order to perform processes described herein. Processor 126 may include one or more processing units, such as one or more CPUs, one or more GPUs, and/or one or more NPUs. Memory 127 may comprise one or more types of memory (e.g., RAM, SRAM, DRAM, EEPROM, Flash, etc.). Disk 128 may include a hard disk drive and/or a solid-state drive. Memory 127 and disk 128 may comprise hardware storage devices.

The computing device 154 may comprise a mobile computing device, such as a tablet computer, that allows a user to access a graphical user interface for the database system 120. A user interface may be provided by the database system 120 and displayed using a display screen of the computing device 154.

A server, such as server 160, may allow a client device, such as the database system 120 or computing device 154, to download information or files (e.g., executable, text, application, audio, image, or video files) from the server. The server 160 may comprise a hardware server. In some cases, the server may act as an application server or a file server. In general, a server may refer to a hardware device that acts as the host in a client-server relationship or to a software process that shares a resource with or performs work for one or more clients. The server 160 includes a network interface 165, processor 166, memory 167, and disk 168 all in communication with each other. Network interface 165 allows server 160 to connect to one or more networks 180. Network interface 165 may include a wireless network interface and/or a wired network interface. Processor 166 allows server 160 to execute computer readable instructions stored in memory 167 in order to perform processes described herein. Processor 166 may include one or more processing units, such as one or more CPUs, one or more GPUs, and/or one or more NPUs. Memory 167 may comprise one or more types of memory (e.g., RAM, SRAM, DRAM, EEPROM, Flash, etc.). Disk 168 may include a hard disk drive and/or a solid-state drive. Memory 167 and disk 168 may comprise hardware storage devices.

The networked computing environment 100 may provide a cloud computing environment for one or more computing devices. In one embodiment, the networked computing environment 100 may include a virtualized infrastructure that provides software, data processing, and/or data storage services to end users accessing the services via the networked computing environment. In one example, networked computing environment 100 may provide cloud-based database applications to computing devices, such as computing device 154.

FIG. 1B depicts one embodiment of the database system 120 including database nodes 141 and 146 in communication with cloud data storage 157 and data storage device 158 via one or more networks 180. The nodes 141 and 146 may comprise two nodes out of multiple database nodes that are networked together and present themselves as a distributed database system. The cloud data storage 157 may correspond with a cloud-based storage (e.g., private or public cloud storage). Data storage device 158 may comprise a hard disk drive (HDD), a magnetic tape drive, a solid-state drive (SSD), a storage area network (SAN) storage device, or a networked-attached storage (NAS) device.

As depicted, node 141 includes a database server 142, global lock manager (GLM) 143, and batch size 144. The batch size 144 may be stored in a memory, such as memory 127 in FIG. 1B. The memory may comprise a volatile or non-volatile memory. The batch size 144 may be dynamically adjusted over time to adjust the number of transactions performed by the node 141 before releasing a node-lock for a page. Node 146 includes a database server 147, local lock manager 148, and batch size 149. The batch size 149 may be stored in a volatile or non-volatile memory. The batch size 149 may be dynamically adjusted over time to adjust the number of transactions performed by the node 146 before releasing a node-lock for a page. Thus, batch sizes may be set and adjusted on a per node basis. Each node may also include a buffer pool (not depicted) for buffering pages as they are transferred to or from a node. The database server 142 and database server 147 may comprise database instances. The local lock manager 148 may correspond with a non-GLM lock manager. The GLM 143 may comprise the global lock manager for the database system 120 that is used to manage database page locks for the database system 120.

Database page locks may be implemented as exclusive locks (or write locks) and shared locks (or read locks). Shared locks may allow a page to be read concurrently by multiple database instances. However, in situations where database transactions have a serializable isolation level, the database transactions may not be allowed to update the page while the shared locks for the page are in place. Unlike shared locks, only one database instance at a time may acquire an exclusive lock for a page. If a second database instance wants to acquire the exclusive lock for the page, then that second database instance must wait until the exclusive lock is released and acquired by the second database instance.

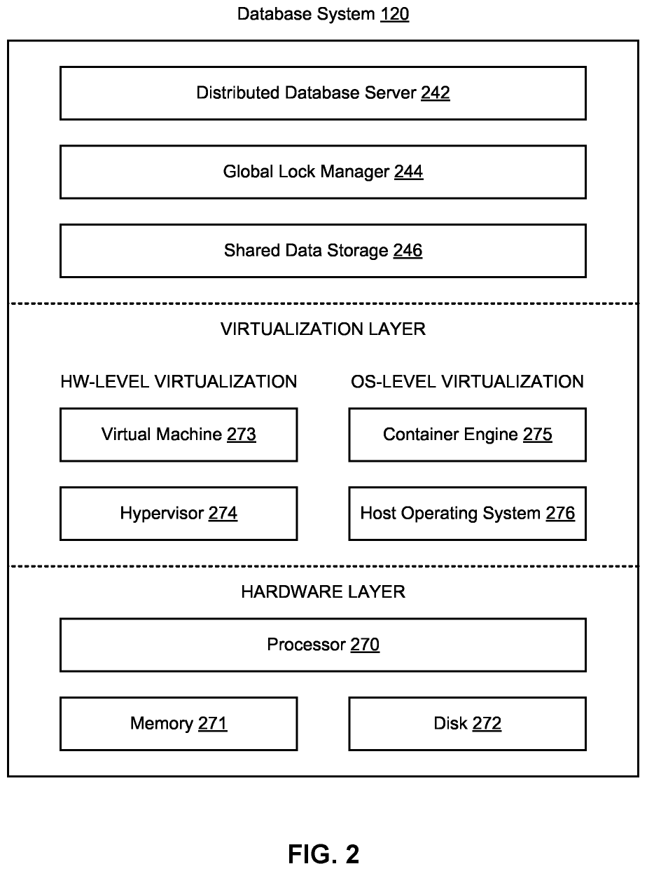

FIG. 2 depicts one embodiment of various components of the database system 120 of FIG. 1B. As depicted, the database system 120 includes hardware-level components and software-level components. The hardware-level components may include one or more processors 270, one or more memories 271, and one or more disks 272. The software-level components may include software applications and computer programs. In some embodiments, the distributed database server 242, global lock manager 244, and shared data storage 246 may be implemented using software or a combination of hardware and software. In some cases, the software-level components may be run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

In some embodiments, the distributed database server 242 may include a plurality of nodes, such as nodes 141 and 146 in FIG. 1C. Each of the plurality of nodes may access data stored within the shared data storage 246. The global lock manager 244 may control node-locks for pages stored within the shared data storage 246. The global lock manager 244 may run on one of the plurality of nodes.

As depicted in FIG. 2, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications, such as applications for the distributed database server 242. The virtual machine 273 may run the host operation system 276 upon which the container engine 275 may run.

A container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

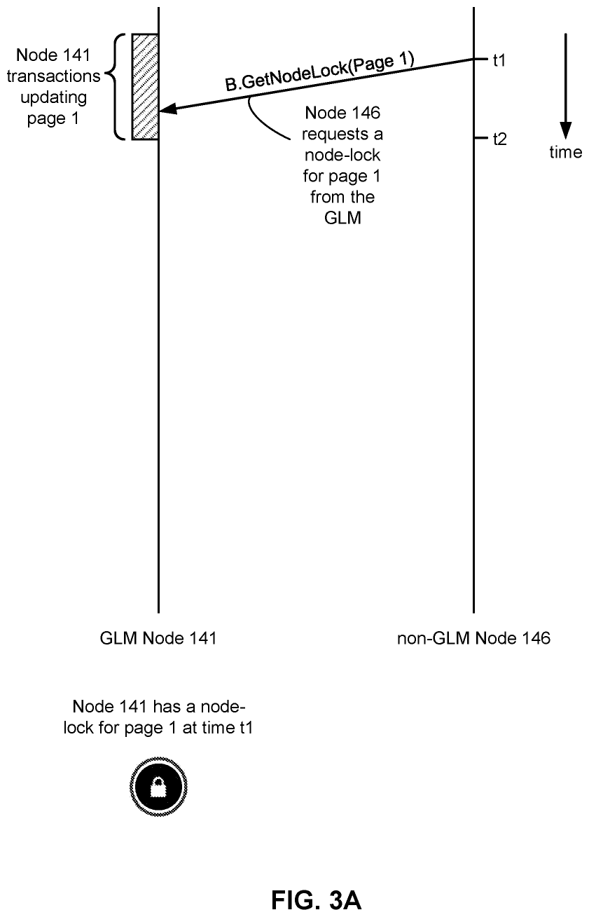

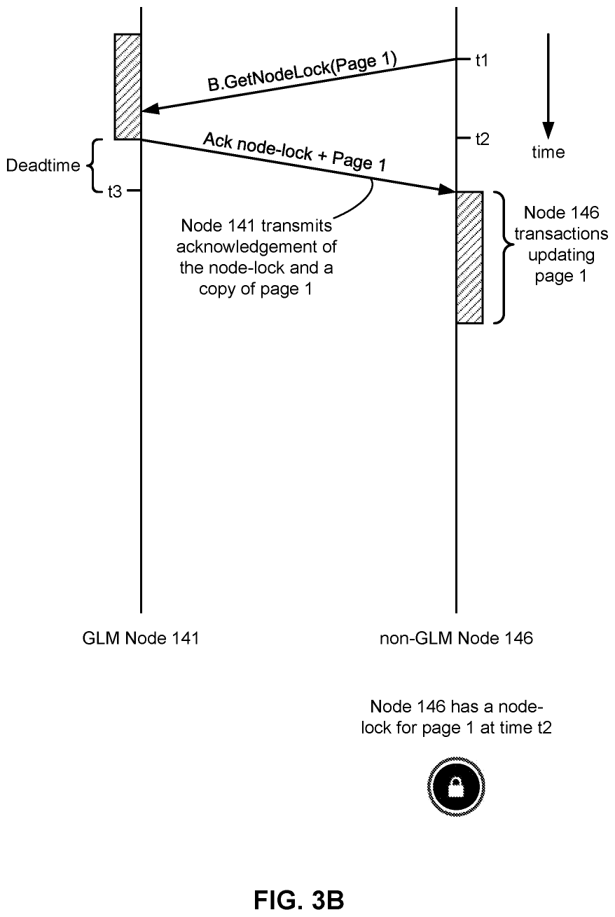

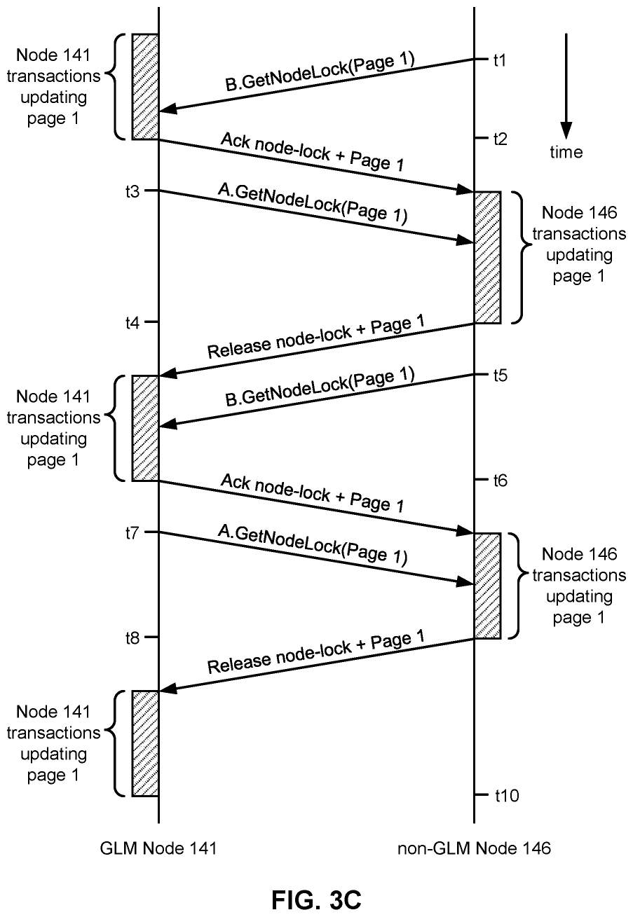

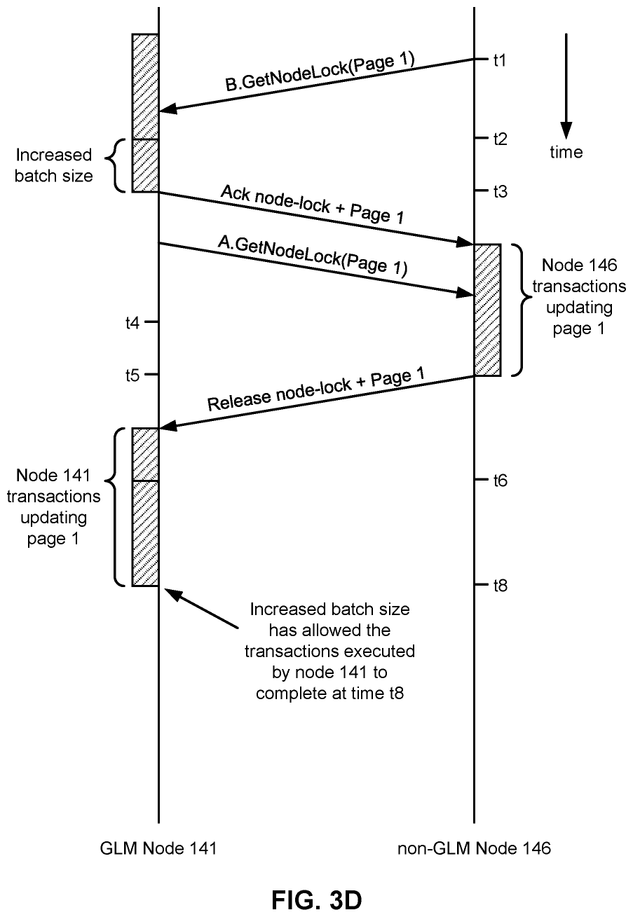

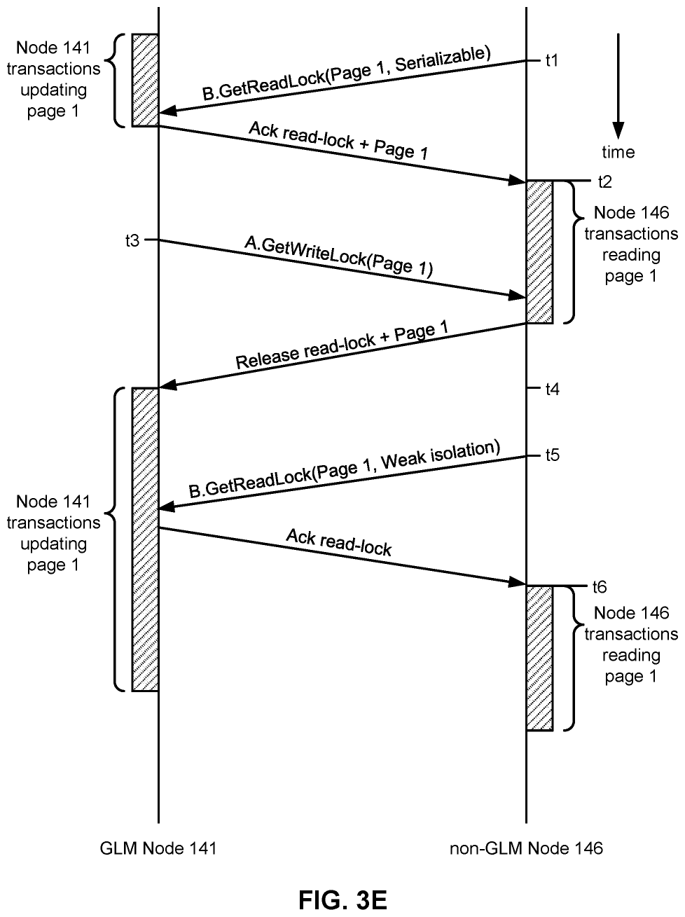

FIG. 3A depicts one embodiment of transactions being performed by the two database nodes 141 and 146 and message passing occurring between the two database nodes. At time t1, the node 146 has transmitted a request to obtain a node-lock for page 1 via the command B.GetNodeLock(Page 1) to the global lock manager run by node 141. The node 146 may correspond with a Node B and the node 141 may correspond with a Node A. Thus, B.GetNodeLock(Page 1) may refer to Node B requesting a node-lock for Page 1. At time t1, the node 141 has a node-lock for page 1 and subsequently receives the request from the node 146 to obtain the node-lock for page 1 while the node 141 is executing transactions that are updating page 1. In some cases, the node 141 may delay until completion of the transactions up to the maximum batch size before releasing the node-lock for page 1.

FIG. 3B depicts one embodiment of transactions being performed by the two database nodes 141 and 146. At time t2, the global lock manager running on node 141 sets the node-lock for page 1 to be locked by node 146 and transmits an acknowledgment of the node-lock to node 146, as well as a copy of the updated page 1. At time t3, the node 146 receives the acknowledgment of the node-lock. The time difference between times t2 and t3 comprises deadtime as node 146 cannot start executing transactions that update page 1 until node 146 receives the acknowledgment of the node-lock.

FIG. 3C depicts one embodiment of transactions being performed by the two database nodes 141 and 146. At time t3, the node 141 transmits a request to obtain a node-lock for page 1 via the command A.GetNodeLock(Page 1). The node 141 may transmit the request to the global lock manager and/or to the node 146 that has the node-lock for page 1 at time t3. At time t4, the node 146 transmits a release of the node-lock to the global lock manager running on the node 141. Subsequently, at time t5, the node 146 transmits a request to obtain the node-lock for page 1. At time t6, the node 141 transmits an acknowledgment that node 146 has obtained the node-lock for page 1. At time t7, the node 141 transmits a request to obtain a node-lock for page 1. At time t8, the node 146 transmits a release of the node-lock for page 1. As depicted in FIG. 3C, the transactions executed by node 141 are completed at time t10.

FIG. 3D depicts another embodiment of transactions being performed by the two database nodes 141 and 146. At time t1, the node 141 running the global lock manager is executing transactions that are updating page 1. When the node 141 receives the request from node 146 to obtain a node-lock for page 1, the node 141 has not completed a number of transactions that are less than a batch size for node 141. In response to detection that a request for a node-lock for page 1 has been received while the node 141 has not completed executing the number of transactions that are less than the batch size for node 141, the node 141 may automatically increase the batch size for node 141 by a first number of transactions (e.g., increasing the batch size by one). At time t3, the node 141 has completed executing a number of transactions equal to the updated batch size and transmits an acknowledgment that the node-lock has been set for node 146. At time t5, the node 146 transmits a release of the node-lock to the node 141. Thereafter, node 141 completes executing transactions that update page 1. As depicted in FIG. 3D, the transactions executed by node 141 are completed at time t8, which is earlier in time than time t10 in FIG. 3C. Thus, increasing the batch size for node 141 has allowed the node 141 to complete the transactions in a shorter amount of time.

FIG. 3E depicts another embodiment of transactions being performed by the two database nodes 141 and 146. At time t1, node 141 running the GLM has a write lock on page 1 and is executing transactions that are making updates to page 1. Also, at time t1, node 146 transmits a request to the GLM to obtain a read lock for page 1 and specifies that one or more transactions to be executed by node 146 require a serializable isolation level. In response, after node 141 releases its write lock on page 1, the GLM transfers an updated (or most-recent) copy of page 1 along with an acknowledgement that node 146 has obtained the desired read lock for page 1. Because a serializable isolation level is required by the one or more transactions to be executed by node 146, not only must node 141 send the most-recent copy of page 1 to node 146, but also node 141 must release its write lock on page 1 before the GLM grants the desired read lock to node 146. The acknowledgement that node 146 has obtained the desired read lock for page 1 is received at node 146 at time t2. Subsequently, at time t3, node 141 requests a write lock for page 1 from the GLM and node 141 transmits information specifying that a write lock for page 1 has been requested. At time t4, node 141 receives a message from node 146 that node 146 has released the read lock for page 1. Also, at time t4, the GLM sets a write lock for page 1 and node 141 begins executing transactions that write to or update page 1. At time t5, node 146 transmits a request to the GLM to obtain a read lock for page 1 and specifies that one or more transactions to be executed by node 146 do not require a serializable isolation level or only require a read uncommitted isolation level in which a transaction may read data even if changes have not yet been committed by another transaction. In response, the GLM does not transfer an updated (or most-recent) copy of page 1 along with the acknowledgement that node 146 has obtained the desired read lock for page 1. The acknowledgement that node 146 has obtained the desired read lock for page 1 is received at node 146 at time t6.

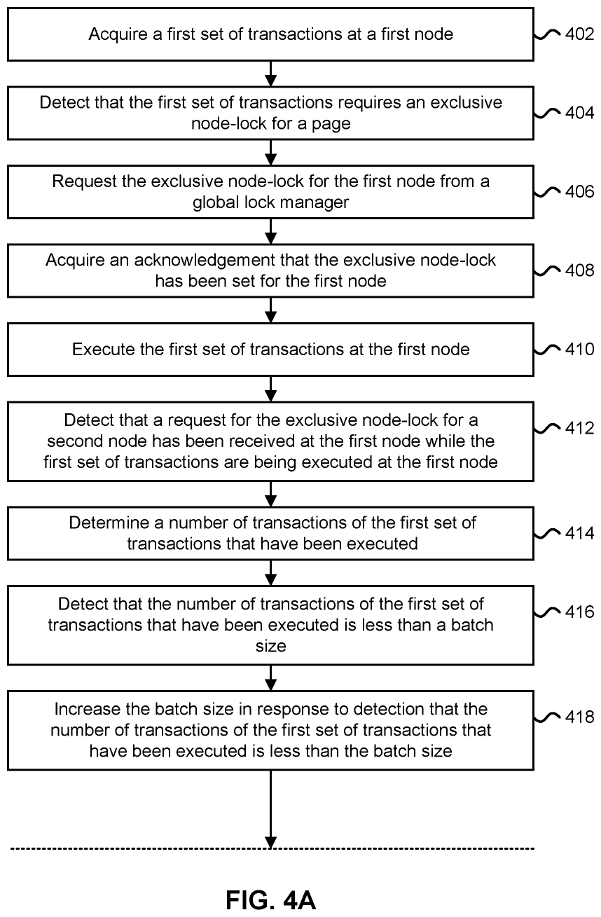

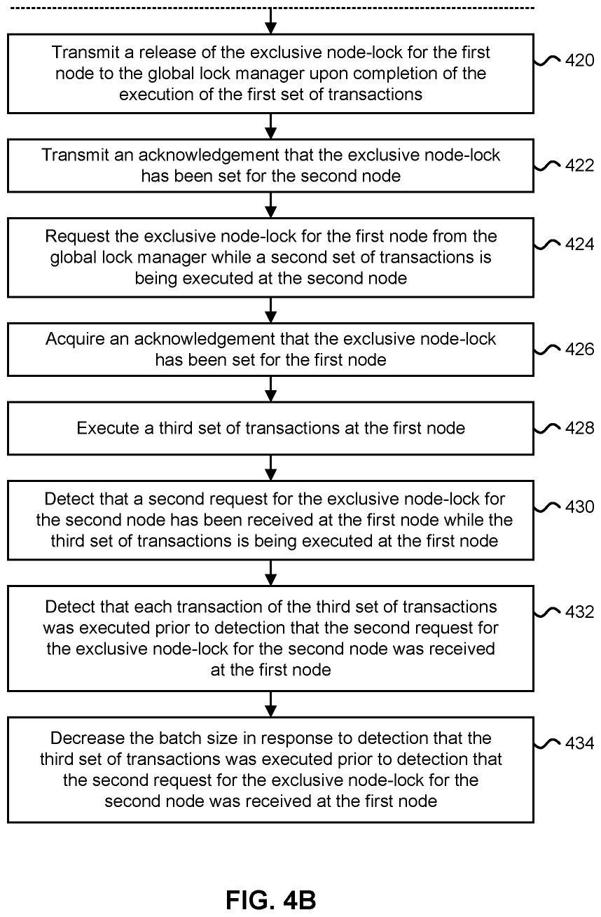

FIGS. 4A-4B depict a flowchart describing one embodiment of a process for dynamically adjusting batch size while executing database transactions. In one embodiment, the process of FIGS. 4A-4B may be performed by a database system, such as the database system 120 in FIG. 1C. In another embodiment, the process of FIGS. 4A-4B may be implemented using a cloud-based computing platform or cloud-based computing services.

In step 402, a first set of transactions is acquired at a first node. The first node may correspond with node 141 in FIG. 1C. In one example, the first set of transactions may comprise one or more transactions for updating data stored within a database. In step 404, it is detected that the first set of transactions requires an exclusive node-lock for a page. In step 406, a request for the exclusive node-lock for the first node is made to a global lock manager. The global lock manager may be executed by the first node. In step 408, an acknowledgment that the exclusive node-lock has been set for the first node is acquired. In step 410, the first set of transactions is executed at the first node or using computing resources of the first node.

In step 412, it is detected that a request for an exclusive node-lock for a second node has been received at the first node while the first set of transactions are being executed at the first node. In reference to FIG. 3D, the node 141 may receive a request for an exclusive node-lock for page P from node 146 while executing transactions that are making updates to page P.

In step 414, a number of transactions of the first set of transactions that have been executed is determined. The number of transactions of the first set of transactions may correspond with the transactions that have been executed by the first node since the acknowledgment that the exclusive node-lock has been set for the first node was acquired in step 408. In step 416, it is detected that the number of transactions of the first set of transactions that have been executed is less than a batch size. The first node may store a batch size for the first node within a memory of a database server, such as the database server 142 in FIG. 1C. The first node may dynamically increase or decrease the batch size for the first node based on an average message delay for setting and releasing node-locks, a network bandwidth for a network over which database messages are transmitted to the first node, and/or the number of times that a node-lock has ping-ponged between the first node and another node within a past threshold period of time (e.g., within the past five seconds).

In step 418, the batch size is increased in response to detection that the number of transactions of the first set of transactions that have been executed is less than the batch size at the time that the request for the exclusive node-lock for the second node was received.

In step 420, a release of the exclusive node-lock for the first node is transmitted to the global lock manager upon completion of the execution of the first set of transactions. In step 422, an acknowledgment that the exclusive node-lock has been set for the second node is transmitted. In step 424, the exclusive node-lock for the first node is requested from the global lock manager while a second set of transactions is being executed at the second node. In step 426, an acknowledgment that the exclusive node-lock has been set for the first node is acquired.

In step 428, a third set of transactions is executed at the first node. In step 430, it is detected that a second request for the exclusive node-lock for the second node has been received at the first node while the third set of transactions is being executed at the first node. In step 432, it is detected that each transaction of the third set of transactions was executed prior to detection that the second request for the exclusive node-lock for the second node was received at the first node. In this case, the first node has already completed execution of the third set of transactions. In step 434, the batch size is decreased in response to detection that the third set of transactions was executed and completed prior to detection that the second request for the exclusive node-lock for the second node was received at the first node.

In some embodiments, to avoid sudden changes in the batch size, a database system may introduce hysteresis in order to slow down the rate of batch size increases and/or decreases. In some cases, instead of immediately decreasing the batch size when a node doesn't have enough transactions to fill the batch, the node or the global lock manager will wait at least a threshold number of rounds (e.g., at least three rounds) before reducing the batch size. In one example, although it is detected that a set of transactions that require an exclusive node-lock for a particular page has completed execution prior to detecting a request for an exclusive node-lock for the page for a different node (e.g. node 146 in FIG. 3E) than the node (e.g., node 141 in FIG. 3E), the node or the global lock manager may not decrease the batch size until the number of times that transactions executed by the node have completed prior to receiving an exclusive node-lock request has exceeded at least three times (or three rounds). In this case, on the fourth time, the node or global lock manager may decrease the batch size for the node.

In one embodiment, the amount of the decrease in the batch size for the node may depend on the number of times in a row that transactions executed by the node have completed prior to receiving an exclusive node-lock request. The reduction in the batch size may be set to the number of times in a row that transactions executed by the node have completed prior to receiving an exclusive node-lock request squared or may be equal to the number of times in a row that that transactions executed by the node have completed prior to receiving an exclusive node-lock request.

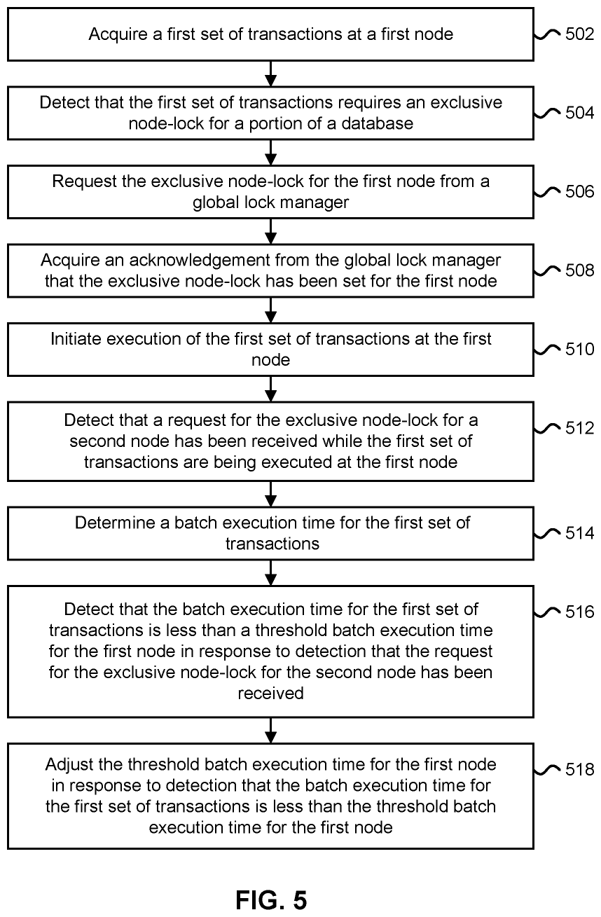

FIG. 5 depicts a flowchart describing an embodiment of a process for dynamically adjusting a batch execution time while executing database transactions. In one embodiment, the process of FIG. 5 may be performed by a database system, such as the database system 120 in FIG. 1C. In another embodiment, the process of FIG. 5 may be implemented using a cloud-based computing platform or cloud-based computing services.

In step 502, a first set of transactions is acquired at a first node. The first node may correspond with node 141 in FIG. 3E. In step 504, it is detected that the first set of transactions requires an exclusive node-lock for a portion of a database. The portion of the database may comprise, for example, a page within the database or one or more database rows. In step 506, the exclusive node-lock for the first node is requested from a global lock manager. The global lock manager may correspond with the global lock manager 244 in FIG. 2. In step 508, an acknowledgement from the global lock manager that the exclusive node-lock has been set for the first node is acquired. In step 510, execution of the first set of transactions at the first node is initiated.

In step 512, it is detected that a request for the exclusive node-lock for a second node has been received while the first set of transactions are being executed at the first node. The second node may correspond with node 146 in FIG. 3E. In step 514, a batch execution time for the first set of transactions is determined. The batch execution time may correspond with an amount of time that the first set of transactions has been executing on the first node. In step 516, it is detected that the batch execution time for the first set of transactions is less than a threshold batch execution time for the first node in response to detection that the request for the exclusive node-lock for the second node has been received. In one example, if the threshold batch execution time for the first node is 2 ms and the amount of time that the first set of transactions was executing on the first node prior to detection that the request for the exclusive node-lock for the second node was received was 1.5 ms, then the batch execution time for the first set of transactions would be less than the threshold batch execution time by 0.5 ms. In this case, the first node may continue to execute the first set of transactions for at least another 0.5 ms before releasing the exclusive node-lock for the first node. In step 518, the threshold batch execution time for the first node is adjusted (e.g., increased) in response to detection that the batch execution time for the first set of transactions is less than the threshold batch execution time for the first node. In some cases, the threshold batch execution time for the first node may be decreased in response to detection that the batch execution time for the first set of transactions is greater than the threshold batch execution time for the first node. Dynamically adjusting the threshold batch execution time for the first node allows the first node to execute a greater number of transactions before releasing an exclusive node-lock when a “hot lock” condition exists.

At least one embodiment of the disclosed technology includes a storage device configured to store a batch size associated with a first node of a plurality of nodes and one or more processors in communication with the storage device. The one or more processors are configured to execute a first set of transactions at the first node while an exclusive node-lock has been set for the first node, detect that a request for the exclusive node-lock for a second node of the plurality of nodes has been received while the first set of transactions is executed at the first node, detect that a number of transactions of the first set of transactions that has been executed at the first node is less than the batch size, and adjust (e.g., increase) the batch size associated with the first node based on the number of transactions of the first set of transactions that has been executed at the first node.

At least one embodiment of the disclosed technology includes initiating execution of a first set of transactions at a first node while an exclusive node-lock has been set for the first node, detecting that a request for the exclusive node-lock for a second node has been received during execution of the first set of transactions at the first node, determining a batch execution time for the first set of transactions, detecting that the batch execution time for the first set of transactions is less than a threshold batch execution time for the first node in response to detection that the request for the exclusive node-lock for the second node has been received, and adjusting (e.g., increasing) the threshold batch execution time for the first node in response to detecting that the batch execution time for the first set of transactions is less than the threshold batch execution time for the first node.

At least one embodiment of the disclosed technology includes executing a first batch of transactions at a first node while a node-lock for a page has been set for the first node, detecting that a second node has requested the node-lock for the page during execution of the first batch of transactions at the first node, detecting that a number of transactions of the first batch of transactions that has been executed at the first node is less than a batch size for the first node, and adjusting the batch size for the first node based on the number of transactions of the first batch of transactions that has been executed at the first node.

At least one embodiment of the disclosed technology includes executing a first set of transactions at the first node, detecting that a request for an exclusive node-lock for a second node has been received at the first node during execution of the first set of transactions at the first node, determining a number of transactions of the first set of transactions that has been executed at the first node, detecting that the number of transactions of the first set of transactions is less than the batch size, and increasing the batch size associated with the first node based on the number of transactions of the first set of transactions that has been executed at the first node.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. All of the U.S. patents, U.S. patent application publications, and U.S. patent applications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a storage device configured to store a batch size associated with a first node of a plurality of nodes; and
one or more processors in communication with the storage device configured to:
execute a first set of transactions at the first node while an exclusive node-lock has been set for the first node;
detect that a request for the exclusive node-lock for a second node of the plurality of nodes has been received while the first set of transactions is executed at the first node;
detect that a number of transactions of the first set of transactions that have been executed at the first node is less than the batch size; and
adjust the batch size associated with the first node based on the number of transactions of the first set of transactions that have been executed at the first node.

2. The system of claim 1, wherein:
the one or more processors are configured to increase the batch size in response to detection that the number of transactions of the first set of transactions is less than the batch size.

3. The system of claim 1, wherein:
the number of transactions of the first set of transactions that have been executed at the first node is less than all of the first set of transactions.

4. The system of claim 1, wherein:
the one or more processors are configured to:
execute a third set of transactions at the first node while the exclusive node-lock has been set for the first node;
detect that each transaction of the third set of transactions was executed at the first node prior to detection that a second request for the exclusive node-lock for the second node was received; and
decrease the batch size associated with the first node in response to detection that each transaction of the third set of transactions was executed prior to detection that the second request for the exclusive node-lock for the second node was received.

5. The system of claim 1, wherein:
the one or more processors are configured to cause the exclusive node-lock for the first node to be released upon detection that a second number of transactions of the first set of transactions equal to the batch size have been executed at the first node.

6. The system of claim 1, wherein:
the one or more processors are configured to determine an amount of reduction in the batch size based on a number of times that transactions executed by the first node have completed execution prior to receiving an exclusive node-lock request for the second node.

7. The system of claim 1, wherein:
the one or more processors are configured to adjust the batch size associated with the first node based on a number of times that the exclusive node-lock has been exchanged between the first node and the second node.

8. The system of claim 1, wherein:
the one or more processors are configured to adjust the batch size associated with the first node based a network latency for a network over which messages are transmitted to the first node.

9. The system of claim 1, wherein:
each transaction of the first set of transactions executes with a read committed isolation level or a serializable isolation level.

10. The system of claim 1, wherein:
the plurality of nodes corresponds with nodes of a distributed database system.

11. A method for operating a database system, comprising:
initiating execution of a first set of transactions at a first node while an exclusive node-lock has been set for the first node;
detecting that a request for the exclusive node-lock for a second node has been received during execution of the first set of transactions at the first node;
determining a batch execution time for the first set of transactions;
detecting that the batch execution time for the first set of transactions is less than a threshold batch execution time for the first node in response to detection that the request for the exclusive node-lock for the second node has been received; and
adjusting the threshold batch execution time for the first node in response to detecting that the batch execution time for the first set of transactions is less than the threshold batch execution time for the first node.

12. The method of claim 11, wherein:
the adjusting the threshold batch execution time for the first node includes increasing the threshold batch execution time for the first node based on a time difference between the batch execution time and the threshold batch execution time.

13. The method of claim 11, further comprising:
releasing the exclusive node-lock for the first node after the threshold batch execution time has elapsed; and
transmitting an acknowledgment to the second node that the second node has acquired the exclusive node-lock.

14. The method of claim 11, further comprising:
initiating execution of a third set of transactions at the first node while the exclusive node-lock has been set for the first node;
detecting that a second request for the exclusive node-lock for the second node has been received while executing the third set of transactions at the first node;
detecting that an amount of time that the third set of transactions has been executing is greater than the threshold batch execution time for the first node; and
decreasing the threshold batch execution time for the first node in response to detecting that the amount of time that the third set of transactions has been executing is greater than the threshold batch execution time for the first node.

15. The method of claim 14, wherein:
the decreasing the threshold batch execution time for the first node includes determining an amount of reduction in the threshold batch execution time based on a number of times that transactions executed by the first node have completed execution prior to receiving an exclusive node-lock request for the second node.

16. The method of claim 11, wherein:
the adjusting the threshold batch execution time for the first node includes adjusting the threshold batch execution time for the first node based on a number of times that the exclusive node-lock has been exchanged between the first node and the second node.

17. A method for operating a database system, comprising:
executing a first batch of transactions at a first node while a node-lock for a page has been set for the first node;
detecting that a second node has requested the node-lock for the page during execution of the first batch of transactions at the first node;
detecting that a number of transactions of the first batch of transactions that have been executed at the first node is less than a batch size for the first node; and
adjusting the batch size for the first node based on the number of transactions of the first batch of transactions that have been executed at the first node.

18. The method of claim 17, further comprising:
detecting that a number of the first batch of transactions equal to the batch size have completed execution at the first node;
releasing the node-lock for the page for the first node in response to detecting that the number of the first batch of transactions equal to the batch size have completed execution at the first node; and
transmitting an acknowledgment to the second node that the second node has acquired the node-lock for the page.

19. The method of claim 17, wherein:
the adjusting the batch size for the first node includes increasing the batch size for the first node based on a difference between the batch size and the number of transactions of the first batch of transactions that have been executed at the first node.

20. The method of claim 17, wherein:
the number of transactions of the first batch of transactions that have been executed at the first node is less than all of the first batch of transactions.
